(19) United States
(12) Patent Application Publication
(10) Pub. No.: US 2006/0188238 A1
(43) Pub. Date: Aug. 24, 2006

(54) Solar heated & powered ultrasonic air freshener diffuser

(76) Inventor: Carl Ernest Kent, Eden Prairie, MN (US)

Correspondence Address: MERCHANT & GOULD PC, P.O. BOX 2903, MINNEAPOLIS, MN, 55402-0903, US

(21) Appl. No.: 11/329,807

(22) Filed: Jan. 10, 2006

Related U.S. Application Data
(60) Provisional application No. 60/656,459, filed on Feb. 23, 2005.

(51) Int. Cl. A61H 33/06

(52) U.S. Cl. 392/394; 422/125; 392/386

(57) ABSTRACT

An air freshener apparatus to atomize and diffuse liquids or suspensions into a mist by means of conversion of collected solar energy into thermal radiation passed through a wire for optionally heating said liquids and conversion of solar energy into electrical energy stored in batteries and used for subsequent atomization of said optionally heated liquids by means of piezoelectric ultrasonic vibrations. In one embodiment, the resulting mist and fragranced aromas of atomized liquids or suspensions are communicated through housing vent openings to an external environment such as a room or an automobile. In an alternative embodiment, additional diffusion of said atomized liquids and associated fragranced aromas is achieved by means of connecting the present invention, with its attachable clip, to the louvers of a building's or an automobile's ventilation system that, when blowing air, provides additional diffusion of fragrance into the air inside of a building or an automobile.

### RELATED APPLICATION(S)

This application claims priority to U.S. Provisional Application No. 60/656,459, filed Feb. 23, 2005. Application No. 60/656,459 is incorporated herein by reference in its entirety.

### FEDERALLY SPONSORED RESEARCH OR DEVELOPMENT

Not applicable.

### SEQUENCE LISTING OF TABLES OR COMPUTER PROGRAMS OR COMPACT DISC

Not applicable.

### BACKGROUND OF THE INVENTION

1. Technical Field

This invention relates to a novel solar energy apparatus and more particularly relates to a new utility process and apparatus for absorbing, transferring and storing solar energy for subsequent use in optional heating fragranced liquids and suspensions that are stored in a dispenser, and for use in creating piezoelectric ultrasonic vibrations to atomize said fragranced liquids and suspensions on a plate, and for and subsequent distribution of resulting fragranced mist. More specifically, the invention relates to an improvement in the rate of atomization due to the use of a heating element, an improvement in the efficient use of electricity by means of constant recycling of renewable solar energy to recharge batteries, and an improvement in diffusing atomized liquids by means of using the air movement provided by the ventilation system of a building or an automobile for dispensing a fragrance or air freshener, or other materials, in the form of a fine spray for air freshening in an enclosed environment.

The use of piezoelectric vibrators to atomize liquids is well known. In general, these devices apply an alternating voltage to a piezoelectric element to cause it to expand and contract. The piezoelectric element is connected to a perforated membrane sometimes ceramic, sometimes metallic such as nickel, which in turn is in contact with a liquid dispensing source. The expansion and contraction of the piezoelectric element causes the membrane to vibrate up and down forming a bow, the force of which causes the water molecules of the liquid to separate from their attractive force to other molecules, whereupon non-water liquid molecules are driven into the membrane's perforations and are then thrown upwardly in the form of a fine mist. Problems with these attempts to atomize liquids by deploying piezoelectric vibrators include a significant shortcoming in that these methods loose efficiency in the atomization process because solely rely on cold air diffusion since they fail to heat the volatile liquids prior to atomization. Specifically, failure to make provisions for heating the liquid slows the rate at which the liquid is absorbed by a wicking device in the storage tank and subsequently slows the transfer rate by which the liquid is transferred to the membrane for vibrated atomization.

The distribution of liquids by formation of a fine spray, or atomization, is well known. One method for such distribution is to atomize a liquid by means of the acoustic vibration generated by an ultrasonic piezoelectric vibrator. We are taught that these processes of atomization and distribution via ultrasonic piezoelectric vibration rely solely on cold air diffusion and on inefficient and unpredictable ambient air movement as a means to communicate fragranced atomized liquids away from the apparatus to the surrounding environment.

Further, we are taught that some of these methods of atomization can be powered by alternating current from a electrical standard outlet or by novel use of portable alkaline batteries with voltage outputs that steadily decline over the useful life of the batteries. With these solutions, there are no methods or means given to use renewable energy sources. Problems with using non-renewable sources of energy in the atomization and distribution of liquids include significant shortcomings in the form of higher consumption of electricity, higher operating costs for the consumer, and in the case of battery driven devices, degradation of those devices' performance eventually occurs, even when setting such devices at resonant frequencies, as their voltage output steadily declines over the useful life of batteries.

When looking at traditional non-ultrasonic air fresheners, it is well known to provide electrical heating devices for dispensing such materials as air fresheners, deodorizers, and insect control materials. Such devices often comprise a liquid reservoir of liquid to be dispensed, an electric heater to warm the liquid to cause it to vaporize more readily, and an electrical plug to plug the device into an electric outlet for power. However, it is also known that if such devices are plugged into the lower of two vertically oriented outlets, the consumer may choose to employ the upper outlet for another plug-in apparatus, such as a night light or an electrical cord for an appliance. Such apparatus may be subject to damage or deterioration from the vapors or fumes of the liquid material which is heated and dispensed, possibly resulting in the exposure of live electrical parts, since it is known that many of the fragrance oils used in the preparation of such dispensers contain solvents which dissolve or react with such plastics as styrene, which is frequently used for, as an example, night light assemblies due to its low cost and formability. Moreover, the use of such prior art dispensers results in the consumption of a non-renewable energy source, loss or sacrifice of an electrical outlet, frequently in an area where extra outlets are at a premium, such as on a kitchen or bathroom counter. This is particularly a problem when such dispensers are of such a dimension as to completely cover a vertically oriented wall receptacle, thus utilizing one of the two outlets therein, and covering the second.

2. Prior Art References

Suggested Current U.S. Class: 392/395; 392/96; 219/482; 261/26; 422/122

Suggested International Class: F24F 6/08

Field of Search: 219/482, 483, 484, 485, 490, 504, 505, 509, 510; 261/26; 392/96; 392/390; 392/395; 422/122, 125, 180

References Cited [Referenced By]
U.S. Patent Documents

| | | | |
|---|---|---|---|
| 3711023 | June, 1973 | Smith | 239/54. |
| 3832992 | September, 1974 | Trombe et al | 126/270. |
| 3863621 | February, 1975 | Schoenfelder | 126/270. |
| 3930796 | January, 1976 | Haensel | 422/180. |
| 3990848 | November, 1976 | Corris | 422/49. |
| 4002159 | January, 1977 | Angilletta | 126/429. |
| 4324226 | September, 1977 | Cook | 126/632. |
| 4068652 | January, 1978 | Worthington | 126/603. |
| 4074111 | February, 1978 | Hunter | 422/125. |
| 4100914 | July, 1978 | Williams | 126/429. |
| 4324226 | April, 1982 | Beck | 126/430. |
| 4424804 | January, 1984 | Lee | 126/572. |
| 4533082 | August, 1985 | Moehara et al. | 239/102 |
| 4579717 | April, 1986 | Gyulay | 422/125. |
| 4632311 | December, 1986 | Nakone et al. | 239/101 |
| 4647428 | March, 1987 | Gyulay | 422/4. |
| 4808347 | February, 1989 | Dawn | 261/30. |
| 4837421 | June, 1989 | Luthy. | 362 |
| 4849606 | July, 1989 | Martens et al. | 362 |
| 5164740 | November, 1992 | Irvi | 346/1 |
| 5242111 | September, 1993 | Nakoneczny | 239/47 |
| 5342584 | August, 1994 | Fritz et al. | 422/124. |
| 5422078 | June, 1995 | Colon | 422/123 |
| 5938076 | August, 1999 | Ganzeboom | 222/23. |
| 5938117 | August, 1999 | Irvi | 239/4 |
| 6085740 | July, 2000 | Irvi et al. | 128/200.16. |
| 6197263 | March, 2001 | Blount | 422/125. |
| 6258170 | July, 2001 | Somekh | 118/715. |
| 6264887 | July, 2001 | Farmer | 422/5 |
| 6378780 | April, 2002 | Martens, III et al. | 239/102.2 |
| 6382522 | May, 2002 | Tomkins et al | 239/102.2. |
| 6439474 | August, 2002 | Denen | 239/102.2 |
| 6487367 | November, 2002 | Vieira | 392/395. |
| 6514467 | February, 2003 | Bulsink et al. | 422/122. |
| 6540153 | April, 2003 | Irvi | 239/4. |
| 6632405 | October, 2003 | Lua | 422/124. |
| 6782194 | August, 2004 | Schneiderbauer | 392/395 |
| 6783117 | August, 2004 | Wohrle | 261/26. |
| 6792199 | September, 2004 | Levine et al. | 392/395. |
| 6839506 | January, 2005 | He et al. | 392/392. |

Prior Art; Ultrasonic Vibrating Devices that Atomize Liquids

U.S. Pat. No. 6,439,474 issued to Denen and assigned to S.C. Johnson & Sons, Inc. teaches that it is desired to provide a battery driven piezoelectric atomizer which operates over a long period of time without deterioration of its performance and which permits the use of inexpensive alkaline batteries whose voltage output is known to decrease over the operating life of the battery. As was stated above, problems with using non-renewable sources of energy in the atomization and distribution of liquids include significant shortcomings in the form of higher consumption of electricity, higher operating costs for the consumer, and in the case of a battery driven device as with Denen, degradation of the device's performance eventually occurs, even when setting such device at resonant frequencies as suggested by Denen, as the voltage output steadily declines over the useful life of batteries. Further, with Denen's invention, there are no methods or means given to use renewable energy sources and there are no methods or disclosed to renew battery life. In addition, Denen discloses a method and means for atomizing liquids, but fails to make provision for heating such liquids prior to transport into the atomization membrane, thereby slowing the rate and effectiveness of overall atomization. And further still, in distributing atomized liquids, Denen relies solely on inefficient and unpredictable ambient air movement as a means to communicate fragranced atomized liquids away from the apparatus to the surrounding environment.

Similarly, U.S. Pat. No. 6,540,153 (Irvi assigned to Aerogen); U.S. Pat. No. 6,382,522 (Tomkins et al. assigned to S. C. Johnson); U.S. Pat. No. 6,378,780 (Martens III, et al. assigned to S. C. Johnson); U.S. Pat. No. 5,938,117 (Irvi assigned to Aerogen) all use piezoelectric ultrasonic vibration as a means of atomizing liquids, all use batteries, but all fail to use solar power to renew battery life, none heat the liquids prior to transport into the atomization process, and none attach the apparatus to the ventilations system of either a building or an automobile to diffuse the fragrance of atomized liquids.

U.S. Pat. No. 6,839,506 (He, et al. assigned to Dial Corp.); U.S. Pat. No. 6,085,740 (Irvi et al assigned to Aerogen); U.S. Pat. No. 5,242,111 (Nakoneczny et al.); U.S. Pat. No. 5,164,740 (Irvi assigned to Aerogen), U.S. Pat. No. 4,632,311 (Nakane et al); and U.S. Pat. No. 4,533,082 (Moehara et al) all use piezoelectric ultrasonic vibration as a means of atomizing liquids, but none use batteries or solar energy, none heat the liquids prior to transport into the atomization process, and none attach the apparatus to the ventilation system of either a building or an automobile to diffuse the fragrance of atomized liquids.

Prior Art; Non-Ultrasonic Air Fresheners

The need for effectively combating airborne malodors in homes, enclosed public buildings, and automobiles, by odor masking or destruction, is well established, as is the dispensing of insect control materials for killing or deterring insects. Various kinds of vapor-dispensing devices have been employed for these purposes. The most common of such devices is the aerosol container which propels minute droplets of an air freshener composition into the air. Another common type of dispensing device is a dish containing or supporting a body of gelatinous matter which, when it dries and shrinks, releases a vaporized composition into the atmosphere. Other products, such as deodorant blocks, are also used for dispensing air-treating vapors into the atmosphere by evaporation. Another group of vapor-dispensing devices utilizes a carrier material such as paperboard or a porous plastic or ceramic, impregnated or coated with a vaporizable composition.

A number of recent developments include a liquid or gel air-treating composition in an enclosure, all or part of which is formed of a polymeric film through which the air-treating composition can migrate to be released as a vapor at an outer surface. The use of this type of permeable polymeric membrane controls the dispensing of air-treating vapors, and tends to eliminate great variations in rate of dispensing over the life of the product.

Wicking devices are also well known for dispensing volatile liquids into the atmosphere, such as fragrance, deodorant, disinfectant, or insecticide active agent. A typical wicking device utilizes a combination of a wick and an emanating region to dispense a volatile liquid from a liquid reservoir. Typical wicking devices are described in U.S. Pat. Nos. 1,994,932; 2,597,195; 2,802,695; 2,804,291; 3,550,853; 4,286,754; 4,413,779; 4,454,987; 4,913,350; 5,000,383; and 6,514,467 (Bulsink et al.) all of which are incorporated herein by reference. Unlike improvements in the present invention, these referenced patents fail to make use of heating elements, fail to make use of piezoelectric ultrasonic vibration for atomization and for diffusion, all rely solely on movement of ambient air to disperse fragrance, all solely rely on standard non-renewable electricity, and with the exception of Bulsink et al., and all have no provision for connecting to the ventilation system of an automobile or room.

Of special interest with respect to the present invention are wicking dispenser devices in which the wicking action is promoted by a heat source. This type of wicking device is described in U.S. Pat. Nos. 3,288,556; 3,431,393; 3,482,929; 3,633,881; 4,020,321; 4,968,487; 5,038,394; 5,290,546; 5,364,027; 6,487,367 (Vieira); U.S. Pat. No. 6,782,194 (Schneiderbauer); and U.S. Pat. No. 6,792,199 (Levine) all of which are incorporated herein by reference. Unlike improvements in the present invention, these referenced patents fail to make use of piezoelectric ultrasonic vibration for atomization and for diffusion, all rely solely on movement of ambient air to disperse fragrance, all solely rely on standard non-renewable electricity, and all have no provision for connecting to the ventilation system of an automobile or room.

An additional dispenser of the type often referred to as a plug-in diffuser described in U.S. Pat. No. 4,849,606 (Martens et, al.) which is assigned to S.C. Johnson & Son, Inc., of Racine, Wis. The present invention constitutes an improvement upon this reference, utilizing piezoelectric ultrasonic vibration for atomization and subsequent diffusion, incorporating solar energy as a renewable, abundant energy source, and using a wick systems for more comprehensive, economical transference of fragranced materials.

In U.S. Pat. No. 6,783,117, Wohrle discloses a method and means for delivering scent through a series of replaceable cartridges, but fails to make use of a wick system, solely relies on non-standard electrical power source, and has no provision for connecting to the ventilation system of an automobile or room.

In addition to the above, Luthy discloses, in U.S. Pat. No. 4,837,421, a fragrance dispenser which releases a fragrance from a solid polyamide resin body. The dispenser includes a housing, having at least one opening, disposed adjacent to the resin. A heating resistor is provided in the housing for maintaining an elevated temperature, and a thermally conductive metal heating plate is arranged in the housing in thermally conductive relationship with the heating resistor and configured to at least partially surround and contact the resin body containing the fragrance.

It can be appreciated that air fresheners have been in use for years. Typically, air fresheners are comprised of U.S. Pat. No. 5,342,584, an air freshener device and cartridge with battery as means of power. U.S. Pat. No. 3,711,023 (Smith), and U.S. Pat. No. 6,197,263 (Blount) air freshener devices utilizing an air conditioning system which releases the evaporated volatile substance into the air to produce an odor. U.S. Pat. No. 3,990,848, an air flow induction device air freshening apparatus with a fan mounted in the housing. A fan driven by a motor is connected with the battery. U.S. Pat. Nos. 4,647,428; 4,579,717; 4,407,411; and 3,930796 issued to Gyulay, Gyulay, Hunter, and Haensel respectively are all room air freshening devices that use a light bulb for vaporization of liquid. They work when the light bulb is turned on to heat and vaporize fragrance to permeate the room. The problem with these elastomeric O rings is that these room freshener devices utilize a light bulb that is plugged into the electrical system. The light bulb has to be turned on and at the same time consumes standard, non-renewable electricity to function.

U.S. Pat. No. 6,264,887 issued to Farmer is an air freshening device comprised of a polymer shaped in the form of a clothes-pin with a clip containing apertures impregnated with gel fragrance; the apparatus is attached by means of its clip to the louvers of an automobile ventilation system. A problem with conventional motor-enabled air fresheners are that, as in U.S. Pat. Nos. 6,264,887 and 3,711,023, the devices solely rely on use air conditioning systems (of either automobiles as in the case of U.S. Pat. No. 6,264,887, or automobiles and buildings as in the case of U.S. Pat. No. 3,711,023) to release the evaporated volatile substance into the air to produce an odor. The required utilization of air conditioning systems makes these devices depended on having the air conditioning systems working. Further, with U.S. Pat. No. 6,264,887, the use of a clip to attach to the louvers limits this apparatus to only being functional in automobile ventilation systems for there is no other means of diffusion, whereas in the present invention, the use of a clip to attach the apparatus to the vent louvers of an automobile or room are merely options to aid in diffusion, given that the present invention's use of solar heat and power to atomize liquids and suspensions rapidly diffuses of fragrance.

U.S. Pat. No. 5,422,078 issued to Colon discloses a method and a means to diffuse fragrance into a compartment by means of an apparatus consisting of a reusable holder and replaceable scented polymer cartridges, with the apparatus being clipped to the louvers of the air vents of automobiles, or buildings. Colon makes mention of auxiliary use of a solar powered fan to diffuse fragrance. In significant departures from the present invention, Colon makes no mention of using solar energy for the purpose of generating heat-induced diffusion of fragranced liquids, which in the case of Colon, are injected into a polymer substrate. Instead, to deliver fragrance diffusion, Colon relies on gradual evaporation of a polymer substrate based on surrounding room or automobile vent system temperatures and humidity. Also in difference from the present invention, Colon exclusively uses scented polymer materials as the substrate for impregnated fragrances.

U.S. Pat. No. 6,197,263, Blount, discloses a method and means to diffuse fragranced materials through optional use of solar energy collection from a photovoltaic cell and storage of said solar energy in a battery for warming of a fragranced solid contained in a cartridge. As indicated in the embodiment of Blount's invention, for the apparatus to function, the fragrance cartridge housing must be attached to an automobile's vent system, thereby removing the possibility of the apparatus serving as a stand-alone air freshener for rooms, unlike the present invention which can be used a stand-alone device both in rooms and automobiles. Also, Blount uses a separate component scent cartridge, whereas the present invention needs no cartridges as fragranced liquid scent is poured directly in the liquid storage tank, thereby saving money and providing ease of use in that when the liquid storage tank is empty, the consumer simply refills the storage tank.

U.S. Pat. No. 6,632,405, Lua, discloses a method and means to diffuse fragranced materials through use of solar energy collection from a photovoltaic cell and storage of said solar energy in a battery for the sole use of transferring energy to operate an oscillating fan to diffuse fragranced materials. Unlike the present invention, Lua makes no mention of, and has no apparatus for, converting collecting collecting, and converting solar energy for the purpose of generating radiated heat for use in effecting diffusion of fragranced materials, liquid or solid.

The main problem with conventional air fresheners are that, as in U.S. Pat. Nos. 5,342,584 and 3,990,848, is that the devices need the usage of non-renewable energy batteries or Alternating Current (A/C) from an electrical outlet. The utilization of batteries to power the devices need more attention to the operation of the devices, need the constant change of batteries, add more cost to the device because of the cost of batteries. Another problem with existing products is that, as in U.S. Pat. No. 4,808,347, the air freshening device is plugged into a standard device as in this case the cigarette lighter socket in a vehicle. Another problem with existing inventions is that, as in U.S. Pat. No. 4,808,347, the air freshening device is plugged into a standard cigarette lighter socket in a vehicle. Again, the device is dependent on another device as in this case the cigarette lighter, which on occasion may not be functioning.

While these devices may be suitable for the particular purpose to which they address, they are not as suitable for providing liquid evaporation as a device with solar-powered evaporation and diffusion utilizing the energy derived from natural sunlight or light emitted from regular room light fixture. The solar-power battery is operationally connected to an oscillating device wherein a fan is connected without aid of a wick system. The oscillating or to and fro movement of the fan moves fragrance emitted from the volatile substance of the fragrance out of the housing to the room or vehicle being freshened. The main problem with conventional motor enabled air fresheners are that, as in U.S. Pat. Nos. 5,342,584 and 3,990,848, the devices need the usage of batteries. The utilization of batteries to power the devices need more attention to the operation of the devices, need the constant change of batteries, add more cost to the device because of the cost of batteries.

Another problem is that, as in U.S. Pat. No. 3,711,023, the device solely relies on the air conditioning system to release the evaporated volatile substance into the air to produce an odor. The utilization of the air conditioning system makes the device depended on the time the air conditioning system is working. Yet another problem is that, as in U.S. Pat. No. 4,647,428, the room freshener device utilizes a light bulb that is plugged to the electrical system. The light bulb has to be turned on and at the same time consume electricity to function. Another problem with existing products is that, as in U.S. Pat. No. 4,808,347, the air freshening device is plugged into a standard device as in this case the cigarette lighter socket in a vehicle. Another problem with existing products is that, as in

U.S. Pat. No. 4,808,347, the air freshening device is plugged into a standard cigarette lighter socket in a vehicle. Again, the device is dependent on another device as in this case the cigarette lighter, which on occasion may not be functioning.

Prior Art—Solar Devices

Other types of solar energy collection, storage and transferring devices abound. Solar energy has been used for heating air by a number of investigators. It is well recognized that an enclosure having a transparent window facing the sun will become warm inside. Of particular interest with respect to solar energy devices are those apparatuses which may be efficiently operated yet simple to construct, inexpensive, and easy to maintain. Of particular interest with respect to the consuming public are those solar energy converting devices which may be fabricated in small units, mass produced, allowing use by individual consumers.

In the winter time, the degree of warmth will be greater for (1) black, or absorbing surfaces, (2) insulated sides and back, (3) maximum transparency for solar radiation, (4) maximum opacity for re-radiation from the black surface back through the window, (5) minimum emissivity of the absorber for infra-red, or heat wavelengths, and (6) minimum heat transmission by conduction and convection from the heated surfaces through the window.

Usable systems are possible even when the emissivity for low temperature radiation is as high as the absorptivity for solar energy because of the low emitting temperature of the black surface compared with the temperature of the sun. Therefore, spectrally selective coatings and windows are excellent refinements for optimizing performance.

Much good work has been done in combining the properties of a transmitting window with those of an opaque insulating wall. The best methods use an unshaded, unobstructed, double-glazed window to admit sunshine when the sun is out, and shutters or doors of some kind to block the opening at all other times. Other methods try to be half-window and half-wall, and are thereby, half-effective, although of some apparent use in certain climates.

The prior art as exemplified by U.S. Pat. Nos. 4,324,226, 4,046,133, 3,960,131, 3,832,992, and 4,068,652 is generally illustrative of various solar energy conversion devices utilizing a lens and/or cylindrical tubing while totally omitting use of exterior panels surface coatings for concentrating, collecting and storing energy from the sun's rays. While such devices are generally acceptable for their intended purpose, they have not proven to be entirely satisfactory in that they are complex and expensive to manufacture, bulky and inconvenient to use, functional only in limited areas of the world, exhibit complicated control mechanisms, require unusual skill and knowledge to operate, have not been proven adaptable or feasible (engineering wise or economically) to small scale mass produced consumer applications, and typically can only be utilized after substantial investment.

For example, in examining the spirit of U.S. Pat. No. 4,324,226 to Beck, contrary to a central component of the present invention, Beck discloses a method and means for using glass panes merely as a protective housing or barrier to outside weather elements, with no functionality mentioned, designed or proscribed for using the optical qualities of glass panes to optimize performance (i.e., to increase absorption and/or lower emissivity) in Beck's solar apparatus. Also, Beck discloses a method and means for collecting and storing solar energy through use of cylindrical tubes that would prove bulky, inhibit performance, and prove cost prohibitive in applications using the present invention. Finally, Beck discloses a method and means to transfer solar energy through a series of rotating panels and gears that would prove bulky, inhibit performance, and prove cost prohibitive in applications using the present invention.

U.S. Pat. No. 4,046,133 to Cook discloses a method and a means to convert thermal mass to radiant heat as a terminal achievement. The present invention converts thermal mass to radiant heat, and then uses the radiant heat to effect liquid evaporation and subsequent vapor diffusion by means of electrical motor driven by energy supplied by conversion of previously stored solar thermal mass.

U.S. Pat. No. 3,960,131 to Angilletta, much like Trombe, et al (U.S. Pat. No. 3,832,992), discloses a method and means to collect solar energy from direct sunlight into a darkened surface placed inside a window. Angilletta and Trombe, et al do so with out aid of exterior panels surface coatings for absorption, while the present invention uses exterior panels surface coatings for both absorption and as a sealant to retain heated air and impregnated fluids in the substrate. Also, Angilletta and Trombe, et al, convert thermal mass to radiant heat as a terminal achievement. The present invention converts thermal mass to radiant heat, and then uses the radiant heat to effect liquid evaporation and subsequent vapor diffusion by means of natural air flow or by means of electrical motor driven by energy supplied by conversion of previously stored solar thermal mass.

U.S. Pat. No. 4,068,652 to Worthington discloses a method and means of collecting and storing solar energy through use of metallic substrates, and manifolds, none of which are needed or used in the embodiment of the present invention. Also, Worthington discloses a method and means to reflect condensation, which is not needed or used in the embodiment of the present invention.

As a result of the shortcomings of the prior art, typified by the above, there has developed and continues to exist a substantial need for a solar apparatus which is compact, safe, economical to operate, inexpensive, and provides efficient utilization of available solar energy. Despite this need, and the efforts of many individuals and companies to develop such devices, a safe and efficient solar apparatus has heretofore been unavailable.

### BRIEF SUMMARY OF INVENTION

The present invention is an air freshener apparatus to atomize and diffuse liquids, including essential oils used in aroma therapy, or suspensions into a mist by means of passive collection of solar energy, conversion of collected solar energy into thermal radiation passed through a wire for optional heating said liquids and conversion of solar energy into electrical energy transferred for storage in batteries and used for subsequent atomization and diffusion of said optionally heated liquids by means of piezoelectric ultrasonic vibrations. The present invention provides a novel solar energy apparatus which is readily deployable as a voltage recharging component to renew the energy level of batteries which in turn provide electricity to power the piezoelectric ultrasonic vibrations used to atomize liquids. Also, the apparatus of the invention is self-contained, that is, the apparatus serves both as a solar energy collector/absorber and as an energy storage chamber. Thus, a separate storage device does not have to be constructed. Adaptable for a wide variety of liquid diffusion applications, the current invention improves on the 1970s vision of French scientist and inventor Felix Trombe (original developer of solar energy walls used in conjunction with highly absorbent, low emissivity glass in the construction of dwellings). Through its embodiments, the current invention advances Trombe's theory of solar thermal mass (using the latest solar coating and glazing techniques) and makes solar thermal mass economically practical on aroma diffusion applications. The solar energy apparatus of the invention is simple in design and relatively inexpensive to manufacture and saves the consumer considerable operating expense and total costs of ownership by using renewable energy as opposed to multiple repurchases and throwing away of batteries. Furthermore, the apparatus can be manufactured in a relatively short time. Also, since the solar apparatus can be installed in existing window sashes (either in automobile or dwelling glass), installation is accomplished by an automobile driver or homeowner with no formal or elaborate training or special skills required.

In one embodiment, the resulting mist and fragranced aromas of atomized liquids or suspensions are communicated through housing vent openings to an external environment such as a room or an automobile. In an alternative embodiment, additional diffusion of said atomized liquids and associated fragranced aromas is achieved by means of connecting the present invention, with its attachable clip, to the louvers of a building's or an automobile's ventilation system that, when blowing air, provides additional diffusion of fragrance into the air inside of a building or an automobile.

The piezoelectric vibrating atomizer comprises a solar powered diffuser in conjunction with a substance to be thermally diffused, said substance being retained in a container subject to being heated by an electrical resistance heater. The present invention overcomes these deficiencies of the prior art, by incorporating the use of an optional heating element to allow the user a choice of either cold air diffusion or heated diffusion, a wick system, a piezoelectric vibrating membrane, renewable solar energy for heat and powering the piezoelectric element, and there is a provision to connect to the ventilation system of a building or an automobile. The consumer simultaneously gains an optional heated air freshener, and by not using standard electricity, the consumer need not lose the use of an electrical outlet to plug in the present diffuser, since the present invention is powered by means of solar energy. Because of these advantages with the present invention, the consumer saves money, increases the utility of or otherwise frees up the use of electrical outlets, and automobile lighter slots.

The consumer may replace the air freshener container, such as when the contents thereof have been fully utilized, to change the function of the device, or for aesthetic reasons, such as a desire for a specific fragrance. In this embodiment, the consumer may replace an air freshener element or container with an insecticide element or container, if desired, or with any active suitable for diffusion from a container subject to optional heating to diffuse such active material. Active materials which are suitable for inclusion in the container placed in the receiving chamber of the apparatus of the present invention include volatile active materials selected from the group consisting of fragrances, air fresheners, deodorizers, odor eliminators, odor counteractants, insecticides, insect repellants, herbal substances, medicinal substances, disinfectants, sanitizers, mood enhancers, aroma therapy compositions, and mixtures thereof.

Accordingly, it is an object of this invention to provide a relatively inexpensive room or automobile air freshener which operates safely while unattended, which can take advantage of a free and renewable source of energy, namely solar energy, thereby avoiding wasted energy and which can be easily positioned to the inside of a window found in the typical home or automobile take advantage of and make useful otherwise latent utility of the window's ability to pass solar energy.

Disadvantages of Prior Aroma Diffusion Methods

Piezoelectric Ultrasonic Atomized Based Air Fresheners

Prior attempts to diffuse or distribute liquids by formation of a fine spray center on atomizing a liquid by means of the acoustic vibration generated by an ultrasonic piezoelectric vibrator. We are taught that these prior processes of atomized distribution via ultrasonic piezoelectric vibration have significant shortcomings such as; 1) Less than Optimal Diffusion: Prior inventions rely solely on inefficient and unpredictable ambient air movement as a means to communicate atomized fragranced liquids away from the apparatus to the surrounding environment, 2) Expensive Operating Cost: Because prior inventions use batteries without methods or means for recharging the batteries while in operation, such apparatuses are subject to performance degradation, including declining ability over time to diffuse aromas as the battery loses voltage over its useful life, which as shown in FIG. 12 is about 300 minutes (or 5 hours) of use before a 1.2 V AA battery degrades below 1V of energy, thus halting operation of connected devices and requiring replacement of batteries or plug-in to electrical outlet, and 3) Less than Optimal Atomization Rates: The rate of aroma diffusion is slowed in prior atomization attempts because they solely rely on cold air diffusion, thereby failing to optionally heat the volatile liquids prior to atomization. Specifically, failure to optionally heat the liquids slows the rate at which the liquid is absorbed by a wicking device in the storage tank and subsequently slows the transfer rate by which the liquid is transferred to the membrane for vibrated atomization.

Non-Piezoelectric Ultrasonic Atomized Based Air Fresheners

1) Utilizes room temperature evaporation and sublimation technology that results in unevenly distributed product, 2) Rely on standard, non-renewable electricity to effect liquid evaporation, 3) odor canceling abilities of scent appear to fade after about 2 weeks, not 8-10 weeks as advertised and 4) relative to the present invention are more expensive to manufacture (in labor and materials) and are therefore less economical to the consumer, both in terms of other products' up-front purchase price and recurring energy costs to operate.

Advantages and Benefits of the Present Invention

Although a variety of delivery systems exist, (see FIG. 10) to those skilled in the art, the present invention is differentiated in performance from prior arts by the present invention's ability to provide:
High Quality Diffusion: Aroma is slowly, gently, and evenly diffused many hours after solar energy capture, even after sunset, with optionally heated liquids to increase rates of atomization and diffusion, with aid of the ventilation systems of automobiles and buildings to distribute aroma, and with substantially longer periods of operation and fewer intervals of interruption of, or degradation to performance as seen with prior battery operated atomization diffusion attempts. Traditional evaporation based products without electrical or mechanical means rapidly diffuse aromas in an uncontrolled manner, thus quickly losing their effectiveness.
Long Lasting Life: As an example, rechargeable 1.2 V AA 2200 ma/hr batteries, as shown in FIG. 15 can be recharged 500 times (providing useful life of 150,000 minutes or 2,500 hours) before meeting degradation thresholds versus 300 minutes (or 5 hours) of operation as shown in FIG. 12 before a non-rechargeable 1.2 V AA battery degrades below 1V of energy, thus interrupting operation of connected devices and requiring replacement of batteries or plug-in to electrical outlet. Typical cycle times to distribute aromas by means of the present invention are 35 ml per hour for 4 hours per cycle before depleting the refillable liquid storage tank, with diffusion coverage of up to 900 cubic feet. In the same time frame, traditional air evaporation aroma diffusion systems distribute aromas cover up to 100 cubic feet.
Affordable: Given its long lasting life and significant reduction in replacement rates of batteries, the total costs of ownership in the present invention is economical and substantially less than prior inventions largely because the product uses an unlimited, free and renewable energy source-the sun.
Earth Friendly: All materials are safe for consumers to use, utilize recycled content where possible, and the apparatus is powered by renewable energy.
Other benefits and advantages of the novel solar energy apparatus of the present invention will be apparent from the above description and the accompanying drawings.

### BRIEF DESCRIPTION OF THE FIGURES

FIG. 1 is a vertical side elevation of one form of the novel solar energy absorbing, energy storage, and liquid atomizing air freshener apparatus of the invention;

FIG. 2 is a front view in section of the twist-off housing of the solar energy absorbing, energy storage, and liquid atomizing air freshener apparatus shown in FIG. 1;

FIG. 3 is a rear vertical view in section of the solar energy absorbing, energy storage, and liquid atomizing air freshener apparatus shown in FIG. 1;

FIG. 4 is a front view in section of the water storage tank and fragmented view of the filter/wick system assembly of the solar energy absorbing, energy storage, and liquid atomizing air freshener apparatus shown in FIG. 1;

FIG. 5 is a fragmented top view of the Piezoelectric ultrasonic vibrator of the solar energy absorbing, energy storage, and liquid atomizing air freshener apparatus shown in FIG. 1;

FIG. 6 is a fragmented view of the removable housing, filter assembly and replaceable wick system of the solar energy absorbing, energy storage, and liquid atomizing air freshener apparatus shown in FIG. 1;

FIG. 7 is a front view of the filter assembly and replaceable wick of the solar energy absorbing, energy storage, and liquid atomizing air freshener apparatus shown in FIG. 1;

FIG. 8 is a fragmented rear view of the housing and optional electrical plug of the solar energy absorbing, energy storage, and liquid atomizing air freshener apparatus shown in FIG. 1;

FIG. 9 is a view of the clip to hold the apparatus shown in FIG. 1 to louvers of an automobile or building ventilation system;

FIG. 10 is an illustrative chart of the various fragrance storage and aroma diffusion technologies available, with a description of the advantages and disadvantages of each;

FIG. 11 is a charging curve (at 0.1 C) showing changes in stored voltage versus changes in time for a Nickel Metal Hydride (Ni-MH) 1.2V AA 2200 ma/hr battery (Model # SDH-50AAH2200) manufactured by the Shida Battery Co.;

FIG. 12 is a discharging curve (at 0.2 C) showing changes in stored voltage versus changes in time for a Nickel Metal Hydride (Ni-MH) 1.2V AA 2200 ma/hr battery (Model # SDH-50AAH2200) manufactured by the Shida Battery Co.;

FIG. 13 is a charging curve (at 0.5 C) showing changes in stored voltage versus changes in time for a Nickel Metal Hydride (Ni-MH) 1.2V AA 2200 ma/hr battery (Model # SDH-50AAH2200) manufactured by the Shida Battery Co.;

FIG. 14 is a discharging curve (at 0.5 C) showing changes in stored voltage versus changes in time for a Nickel Metal Hydride (Ni-MH) 1.2V AA 2200 ma/hr battery (Model # SDH-50AAH2200) manufactured by the Shida Battery Co.; and

FIG. 15 is a Life Cycle Curve showing the cumulative number of sustainable charges versus changes in capacity for a Nickel Metal Hydride (Ni-MH) 1.2V AA 2200 ma/hr (Model #SDH-50AAAH2200) rechargeable battery manufactured by the Shida Battery Co.

### DETAILED DESCRIPTION OF PREFERRED EMBODIMENTS OF THE INVENTION

Summary

The present invention provides a passive solar collection and diffusion process whereby essential oils are optionally heated, atomized and diffused by absorbed and converted solar energy.

The present invention is an air freshener apparatus to atomize and diffuse liquids, including essential oils used in aroma therapy, or suspensions, into a mist by means of passive collection of solar energy, conversion of collected solar energy into thermal radiation passed through a wire for optionally heating said liquids and conversion of solar energy into electrical energy transferred for storage in batteries and used for subsequent atomization and diffusion of cold or optionally heated liquids by means of piezoelectric ultrasonic vibrations. Processes that collectively comprise the present invention include A) Solar Energy Collection, B) Energy Transfer, Conversion, and Storage, C) Liquid Storage, D) Optional Heating of Liquids or Suspensions, E) Transfer of Liquids or Suspensions, F) Atomization of Liquids or Suspensions, G) Diffusion of Atomized Liquids or Suspensions, and H) Administrative Functions.

A) Solar Energy Collection (Glass, Thin Films and Solar Mini Panels)

Glass: (Claim 2)

The apparatus' ability to absorb solar energy is aided by means of placing the apparatus to the inner side of conventional glass panes 3 found in buildings and automobiles (as determined by the temperance, thickness, and emissivity standards of the Uniform Building Code and the United States Department of Transportation, National Highway Traffic Safety Administration, and the Federal Motor Vehicle Safety Standards, respectively) for the apparatus to capture direct sunlight 1, with the short wave sun rays 2 being favorably amplified and long wave sun rays partially filtered by said glass 3 in buildings or automobiles.

In an exemplary embodiment, the present invention works in conjunction with glazing 4 standards set forth by governmental regulatory agencies such as Federal Motor Vehicle Safety Standard No. 205—stipulates Glazing Materials—Passenger Cars, Multipurpose Passenger Vehicles, Trucks, Buses, Motorcycles, Slide-In Campers, and Pickup Covers [designed to carry persons while in motion] (Effective Jan. 1, 1968). This standard specifies requirements for glazing materials for use in motor vehicles and motor vehicle equipment for the purpose of reducing injuries resulting from impact to glazing surfaces. The purpose of this standard is to ensure a necessary degree of transparency in motor vehicle windows for driver visibility, and to minimize the possibility of occupants being thrown through the vehicle windows in collisions.

Thin Films and Solar Mini Panels (Claims 1 and 2)

The present invention employs a plurality of thin films and panels such as highly absorptive, low emissivity amorphous silicon (ASi 7 and 48) or micro-crystalline silicon (m-Csi) or cadmium telluride thin films or solar mini-panels that work in conjunction with the glass of either an automobile or a building to collect solar energy. Several commercially available thin film products exist, including as examples, VHF Technology Inc.'s FlexCell®, ICP Solar's PowerFlex®, and Iowa Thin Film technologies, Inc.'s PowerFilm®. In one example of an individual thin film within the plurality of thin films and panels is a commercially available product such as PowerFilm® model number MP3-37, an ASi thin film product made by Iowa Thin Film Technologies, Inc. Offered in a variety of voltages, operating currents sizes, shapes, and weights PowerFilm® provides a novel solution to the old problem of limited power for wireless portable electronics in that the product has a thin profile (0.01 inches thick), they are lightweight, durable, and it easily integrates with devices for solar recharging or direct power. With modification to soldering and crimping connections brought about by the present invention, PowerFilm® can work in the present application to direct power the apparatus or to recharge AA, AAA, and 6-volt batteries 11. As a multi-layered product, PowerFilm® has increased the stability of its solar collection function. In order to build up useful voltage from thin film cells and to reverse potential inefficiencies of the Staebler-Wronski Effect, in the present invention, and apparent to those skilled in the art, the thin film is put through a laser scribing sequence that enables the front and back of the adjacent cells to be directly interconnected in series, with no need for further solder connection between cells. The thin film is laminated to produce a weather resistant and environmentally robust module, while maintaining low cost of production in mass produced sheets of material. As is the case with most ASi thin film products, PowerFilm® has a blocking diode soldered inline to prevent voltage leakages during non-solar absorbing hours and to block reverse current from flowing backward through the module at any point in time, in particular during times of simultaneous charging of batteries and operation of the apparatus. Thus, the inline blocking diode protects the apparatus from a reverse power flow, thereby protecting against the risk of thermal destruction of solar cells and the apparatus' electronic capabilities.

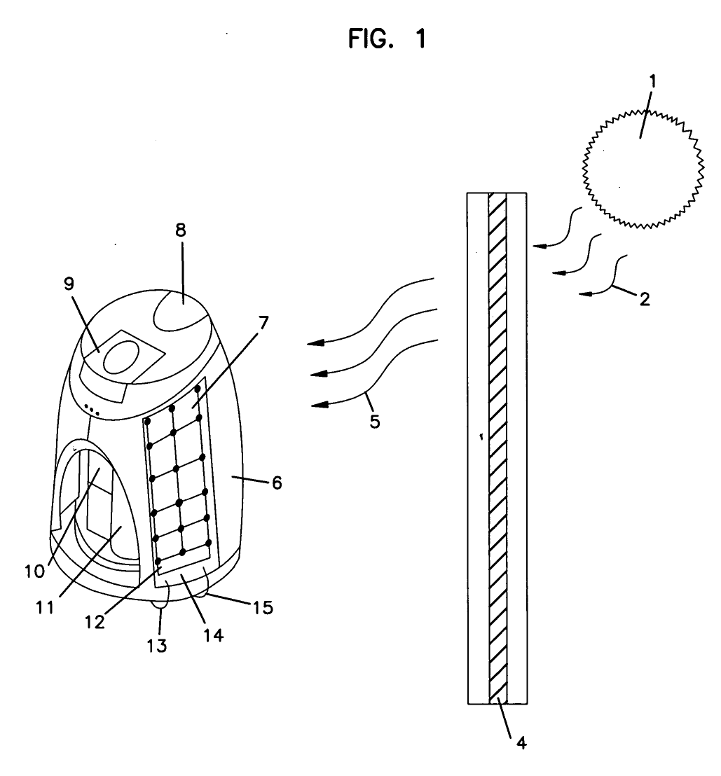

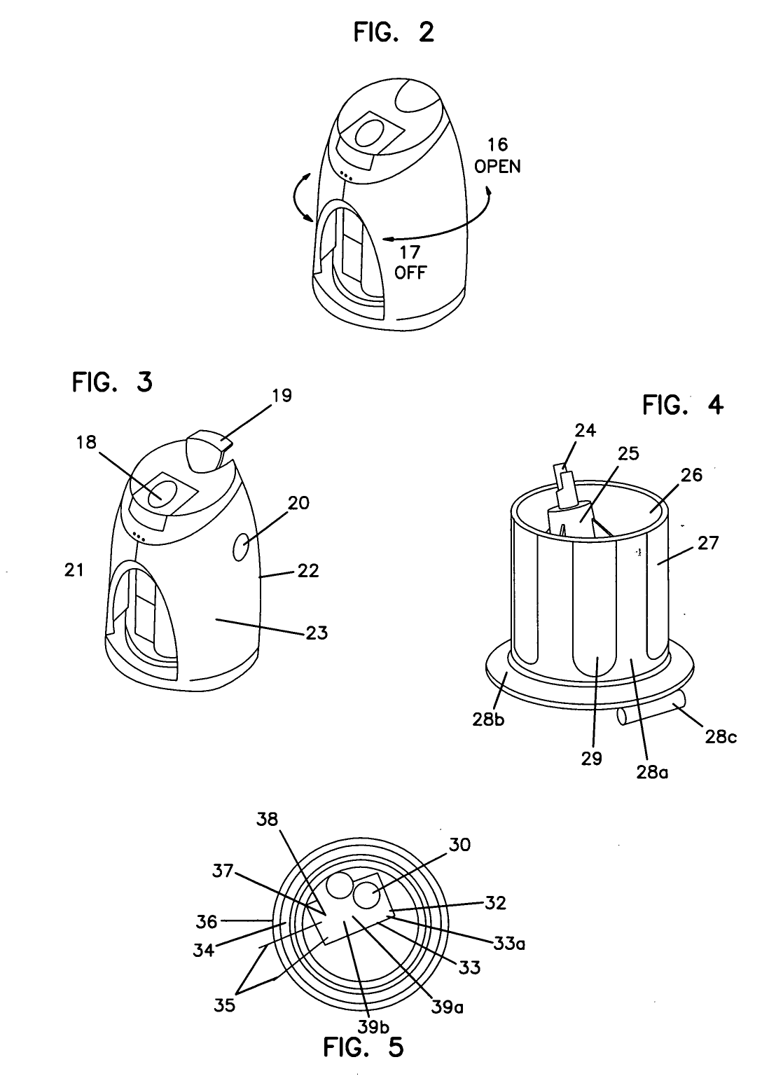

In an exemplary embodiment, as stated in Claim 1, when the sun 1 simultaneously emits long and short wave UV sun rays 2, the glass 3 of either an automobile or building contains glazing films that partially filter long waves and pass through unobstructed short waves. As shown in FIG. 1, the apparatus, being positioned inside the glass 3, either in one embodiment in a sitting position (inside a building window sill or on an automobile dashboard) or in a second embodiment inserted in the vent 55 of an automobile (see FIG. 9) and attached to said vent via clips 53. As the sun rays 2 pass through the glass 3 the short-wave Ultra Violet (UV) rays are aggressively absorbed by the thin film's Phosphorous-doped (N-type) and Boron doped (P-type) silicon layers.

B) Energy Transfer, Conversion & Storage (Claim 2)

In an exemplary embodiment, subsequent to solar energy collection by the thin film's Phosphorous-doped (N-type) and Boron doped (P-type) silicon layers, solar energy is transferred 5 as Direct Current (DC) from these silicon layers to a transparent conducting oxide layer (such as tin oxide 31) which forms the front electrical contact of the cell, and a metal layer (such as copper 39b) which forms the rear contact. The rear copper contact 14 has a lead wire 15 connecting the ASi thin film 7 to the batteries 11. The DC load is then conditioned and transferred to a plurality of commonly available batteries 11 including, but not limited to, AA, AAA, or 6 volt batteries 11, which has an inverter for producing Alternating Current ((AC) and storing the AC for on-going and future load demands. So long as the apparatus is in proximity of a strong enough light source, including the sun or unfiltered indoor light, converted solar energy is continuously transferred to the battery. Using common, commercially available rechargeable batteries, such as those manufactured and sold by Shida Battery Company. Ltd. For example, a rechargeable battery can be fully recharged an average of 500 times before the battery's useful life is concluded. As shown in FIG. 15, illustrating a Shida Battery Company AA 1.2V 2,200 ma/hr rechargeable battery, normal recharge cycling testing indicates a cycle life curve wherein after 500 charges, the ma/hr capacity of the recharged battery is 1,800 ma/hr (or 25% less than new) due to internal corrosion. In comparing life cycles, standard non-rechargeable batteries, as shown in FIG. 12 have a life of about 300 minutes (or 5 hours) of use before a 1.2 V AA battery degrades below 1V of energy, thus halting operation of connected devices, whereas rechargeable batteries can be recharges 500 times (or 150,000 minutes or 2,500 hours) before meeting degradation thresholds.

Thus, the present invention renews or recharges the energy level of the battery even as AC load demands draw down on the battery's reserve, thereby substantially improving resistance to apparatus performance degradation (by a factor of 500 to 1 versus non-rechargeable batteries) due to the rapid decline in voltage associated with non-rechargeable aging alkaline batteries 11 as is the case with prior battery operated piezoelectric ultrasonic vibration liquid atomizing devices. The AC load is used for powering both heat transfer to heating elements (i.e., sheathed lead wires, Positive Co-efficient Temperature-PCT Thermistor 28c and resistors) and for powering the piezoelectric ultrasonic vibrations used to atomize liquid molecules. Alternatively, the lead wire 13 can be connected directly to the Thermistor 28c. Below is an example of performance characteristics of common, commercially available rechargeable batteries such as the 1.2V AA 2200 ma/hr rechargeable battery manufactured and sold by Shida Battery Company, Ltd.

A. Basic

| Type | | Sealed Rechargeable |
|---|---|---|
| | | Ni-MH |
| Model | | SDH-50AAH2200 |
| Size | | AAH |
| Nominal Voltage (V) | | 1.2 |
| Nominal Capacity (mAh) | | 2200 |
| Dimension | Diameter (mm) | 14.5⁺⁰_{-0.7} |
| | Height (mm) | 50.0^{±0.5} |
| Standard | Current (mA) | 220 |
| Charging | Time (h) | 16 |
| Quick Charging | Current (mA) | 880 |
| | Time (h) | 3.5 |
| Rapid Charging | Current (mA) | 1100 |
| | Time (h) | 2.2 |
| Operation | Standard | 0˜45 |
| Temperature(° C.) | Charging | |
| | Rapid Charging | 10˜40 |
| | Discharging | −20˜65 |
| | Storage | −20˜35 |
| | | (RH ≦ 85%) |

| | |
|---|---|
| Permanent Charging Current (mA) | 66˜110 |
| Maximum Discharging Current | 4400 |
| (mA)(continuous) | |
| Impedance (m.) | ≦35 (1000 Hz) |
| Discharge Cut-off Voltage (V) | 1.00 |
| Charge Retention (20° C.) | ≧70% |
| Weight Approx. (g) | 29 |

B. Test Report

Tests are carried out within one month of delivery under the following condition:

1. Ambient Conditions:

Room Temperature 20±5 □

Relative Humidity 65%±20%

2. Capacity Testing

2.1 Standard Charging

0.2 C discharge to 1.00V/cell

0.1 C charging for 16 hours

Rest for 1 hours

0.2 C discharge to 1.00V/cell.

Within 3 charge/discharge cycles, the capacity is no less than 2200 mAh (100%).

2.2 Quick Charging

0.2 C discharge to 1.00V/cell

0.4 C charging for 3.5 hours

Rest for 1 hours

0.2 C discharge to 1.00V/cell.

Within 3 charge/discharge cycles, the capacity is no less than 2090 mAh (95%).

2.3 Rapid Charging

0.5 C discharge to 1.00V/cell.

0.5 C charging for 132 minutes or −ΔV=10 mV/cell.

Rest for 1 hours

0.5 C discharge to 1.00V/cell.

Within 3 charging/discharging cycles, the capacity is no less than 2046 mAh (93%).

3. Open Circuit Voltage (OCV)

After the battery is fully charged, within 1 hour, the OCV is greater than 1.25V/cell

4. Internal Impedance
After the battery is fully charged, within 1 hour, the impedance is not greater than 35 mΩ, as tested by 1000 Hz AC source.

5. Charge Retention
The fully charged battery is held under temperature of 20±2° C. for 28 days, the discharged capacity is no less than 1540 mAh (70%).

6. Overcharging
Under temperature of 20±5° C., the battery is charged at 0.1 C rate for 48 hours. No de-formation of the battery can be found. Standard capacity can be attained under normal discharging operation.

7. Cycle Life

7.1 Normal Cycling Test:

| Cycle No. | Charge | Rest | Discharge |
|---|---|---|---|
| 1 | 0.1 C × 16 hrs | None | 0.25 C × 2 hrs 20 mins |
| 2˜48 | 0.25 C × 3 hrs 10 mins | None | 0.25 C × 2 hrs 20 mins |
| 49 | 0.25 C × 3 hrs 10 mins | None | 0.25 C to 1.0 V/cell |
| 50 | 0.1 C × 16 hrs | 1˜4 hrs | 0.2 C to 1.0 V/cell |

Cycle 1 to 50 shall be repeated until the discharge duration on any 50th cycle becomes less than 3 hrs

After 500 cycles of charging/discharging, capacity 1320 mAh (60%) can be maintained under the cycling test.

7.2 Fast Cycling Test:
Charging: 0.5 C for 126 minutes, under −ΔV control (10 mV/cell)
Rest: 20 minutes
Discharging: 0.5 C to 1.00V/cell
After 300 cycles of charging and discharging, capacity 1320 mAh (60%) can be maintained under the cycling test.

C. Abuse Test

| | Items | Test conditions | Test results |
|---|---|---|---|
| 1. | Overcharge test | 0.1 C for 48 hours | No functional change |
| | | 1 C for 5 hours | Cell venting may |
| | | | occur |
| 2. | Over discharge | Cell is discharged with | No rupture |
| | test (Forced | 0.2 C to 0.00 V, then | No explosion |
| | discharge) | with 1 C forced | Leakage may occur |
| | | discharged for 2 hours | |
| 3. | Short circuit test | Cell is fully charged with | Operation of vent |
| | | 0.1 C for 16 hours, then | Leakage may occur |
| | | shorted for 1 hour or | |
| | | longer with a 10 mΩ | |
| | | load or less | |
| 4. | Vibration test | Cell is vibrated | No physical change |
| | | continuously lengthwise | No leakage |
| | | for 60 minutes | Cell electrical |
| | | Amplitude: 4 mm | performances |
| | | Frequency: | unchanged |
| | | 1000 times/minutes | |
| 5. | Shock test | Cell is dropped 3 times | No rupture |
| | (Drop test) | from a 1.9 m height onto | No leakage |
| | | solid wood (10 mm | |
| | | thick) with random | |
| | | orientation | |
| 6. | Penetration test | Cell is drilled diameter | Temperature |
| | (Hole drilling) | wise with a 4 mm Φ drill | increased to a |
| | | at a depth of less than | maximum of 43° C. |
| | | 1 mm | Leakage from hole |
| | | | area |
| 7. | Crush test | Cell is crushed with | The compressed area |
| | | a vice | heats up to between |
| | | | 500˜800° C. |
| 8. | Water immersion | a. Cell is immersed in | No rupture |
| | test | water for one month | No explosion |
| | | b. Cell is immersed in | |
| | | salt water with a 5% | |
| | | concentration for one | |
| | | month | |
| 9. | Fire exposure test | Cell is thrown into a | Swelling and/or |
| | (Incineration) | charcoal fire | breakage of seal plate |

C) Liquid Storage

In an exemplary embodiment, the liquid reservoir or storage tank 39a and 29 or flask 39a and 29 is made of a plurality of materials, sizes, and shapes and serves as a container for a volatile liquid, suspension, or a liquid containing one or more volatile components can be inserted, in the opening of which container a snugly fitting wick 46 extending into the container and into housing is fitted, a rubberized gasket sealant 34 at and around the neck of the container. The flask 39a and 29 is optionally removable from the apparatus housing or can remain in place for poured refilling with liquids, as is the need once the apparatus has run a series of atomization and diffusion cycles that empty the flask 39a and 29.

D) Heating of Liquids or Suspensions

In an application as an air freshener diffuser, as an option to cold air diffusion, it may be desirable to heat the liquid to be atomized, and in other applications it may be desirable to, in addition, heat the mesh plate, the mesh plate frame, the housing and/or liquid supply conduit/transport line. For example, the liquid may be heated above room temperature to improve absorption into the wick 46, which in turn promotes faster atomization of liquids and diffusion of fragrance. Mesh plate 33 or housing 6 could be heated for these purposes and to prevent condensation of the liquid or spray on these or other elements. For these purposes, an appropriate heater, for example, a resistor, may be employed and controlled through cable.

In an exemplary embodiment permitting optional heating of liquids stored in storage tank 39a and 29, one end the sheathed wire extends into and touches the bottom of the storage tank 39a and 29 while the terminal end of the wire is unsheathed and is optionally connected to an optional resistor, which in turn is connected via a separate wire to an optional PCT Thermistor 28c. The optional PCT Thermistor 28c is connected via a separate wire to the metal conductance clip contacting the battery terminals. The optional PCT Thermistor 28c serves as a means for the user to manually actuate control over the amount of voltage sent to the optional resistor and subsequently the amount of heat communicated to the sheathed wire in the flask 39a and 29, thereby providing the user with control, within a defined range of lower and upper values, over the temperature setting desired for optionally heating the liquids, within a defined range of lower and upper temperature values. The higher the temperature setting is adjusted with the optional Thermistor 28c, higher heat levels will be communicated to the sheathed wired and attendant liquids by increased voltage through the optional resistor. By the user's actuated choice, higher heat levels communicated to the sheathed wire and attendant liquids promote more rapid absorption into the wick 46, which in turn promotes faster atomization of liquids and diffusion of fragrance versus that of cold air diffusion.

E) Transfer of Liquids or Suspensions (Claim 2)

In an exemplary embodiment, a flask 39a and 29 or liquid reservoir 39a and 29, which contains a liquid 31 to be atomized, is mounted below the actuator 39a and membrane 39b. A wick 46 extends up from within the reservoir to the underside of the membrane 39b so that it lightly touches the membrane 39b in the region and so that it contacts the perforations 37. However, the wick 46 should not touch the holes 37 and these holes should be laterally displaced from the wick 46. The wick 46 may be made of a porous flexible material which provides good capillary action to the liquid in the reservoir 39a and 29 so as to cause the liquid to be pulled up to the underside 40 of the membrane 39b. At the same time the wick 46 should be sufficiently flexible that it does not exert pressure against the membrane 39b which would interfere with its vibratory motion. Subject to these conditions, the wick 46 may be made of any of several materials, for example, including but not limited to, paper, nylon, cotton, polypropylene, etc. A preferred form of wick 46 is strand of woven cotton material that is bent back on itself where it touches the membrane 39b. This causes very thin fibers of the strand to extend up to the membrane 39b surface. These very thin fibers are capable of producing capillary action so as to bring liquid up to the membrane 39b; however, these thin fibers do not exert any appreciable force on the membrane 39b which would interfere with its vibratory movement.

F) Atomization of Liquids or Suspensions

A housing with an opening covered by a thin mesh plate that is supplied with the liquid to be atomized on an “on-demand” basis wherein the mesh plate 33 or liquid is vibrated at ultrasonic frequencies to atomize the liquid as it passes through the plate into the diffusion chamber. In operation of the atomizer, alternating electrical voltages from an external source are applied through the leads 35 to electrically conductive coatings on the upper and lower surfaces of the actuator 39a. This produces a piezoelectric effect in the actuator material whereby the actuator expands and contracts in radial directions. As a result, the diameter of the hole 38 increases and decreases in accordance with these alternating voltages. These changes in diameter 38 are applied as radial forces on the membrane 39b; and as a result, the flange region of the plate 33 flexes and pushes the domed center region up and down. This produces a pumping action on the liquid which is brought up against the underside 40 of the center region by the wick 46. The capillary action of the wick 46 causes the pressure of the liquid on the underside 40 of the membrane 39b to be slightly higher than the atmospheric pressure above the membrane 39b. As a result, the liquid 31 is forced upwardly through the perforations 37 and is ejected from the upper surface of the membrane 39b as a mist into the atmosphere.

In an exemplary embodiment, solar heated and powered ultrasonic air freshener diffuser apparatus is connected to a source of material to be atomized. In the embodiment shown in FIG. 1, filter 43 and wick 46 supply material from reservoir 39a and 29 to said apparatus. Reservoir 39a and 29 can be placed at a desired location and can be proximate to, or remote from, solar heated and powered ultrasonic air freshener diffuser apparatus. Control valve 30 and 41 is provided in supply filter 43 and wick 46. Electrical control signals are supplied to control valve 30 and 41 via cable from control unit of piezoelectric element 32. As noted above, the material can comprise an aqueous solution, or a particulate or colloidal suspension. For purposes of explanation, the material undergoing atomization is hereinafter generally described as a liquid. Reservoir 39a and 29 is pressurized by hydrostatic valve 30 in control unit of piezoelectric element 32. In the embodiment shown in FIG. 5, hydrostatic valve 30 supplies a pressurizing gas to reservoir 39a and 29 through wick 46 (FIG. 7).

Solar heated and powered ultrasonic air freshener diffuser apparatus is shown, in detail, in FIG. 8. The apparatus comprises housing 6 which mounts apparatus, which has socket 49 for adapter 50 for optional AC plug-in. Housing 6 may be formed of plastic. Housing 6 has a cavity 26. Interior panels span cavity 26.

Mesh plate frame 33 is received in cavity 26. Frame 28b may be formed of, for example, aluminum or brass. Mesh plate frame 33 has a centrally located aperture. Mesh plate 33 spans the aperture with peripheral edge embedded into interior side of housing 6 at surface. There is an ultrasonic vibration generator in the form of piezoelectric element 33 embedded therein to vibrate housing 6, as well as mesh plate 33. Mesh plate 33, when placed in cavity 26, contacts terminated lead wires 35 in housing 6. Lead wires 35 are thus connected to piezoelectric element 46 70. They are also connected, via lead wires 15 to batteries 11, or optionally, via adaptor plug and cable 50 to an electrical power source in control unit of piezoelectric element 32 having a desired frequency in the ultrasonic range. Typically frequencies range from 6 to 370 kHz. The connections may be carried out by conductors in frame 28b.

Housing 6, frame 28b, and mesh plate 33 and cavity 26 may be generally circular in form. When fitted into housing cavity, the rear or underside surface 40 of mesh plate 33, mesh plate surface and housing surface define an internal liquid volume in the atomizing chamber. Wick 46 extends through housing 6 to open into volume at surface.

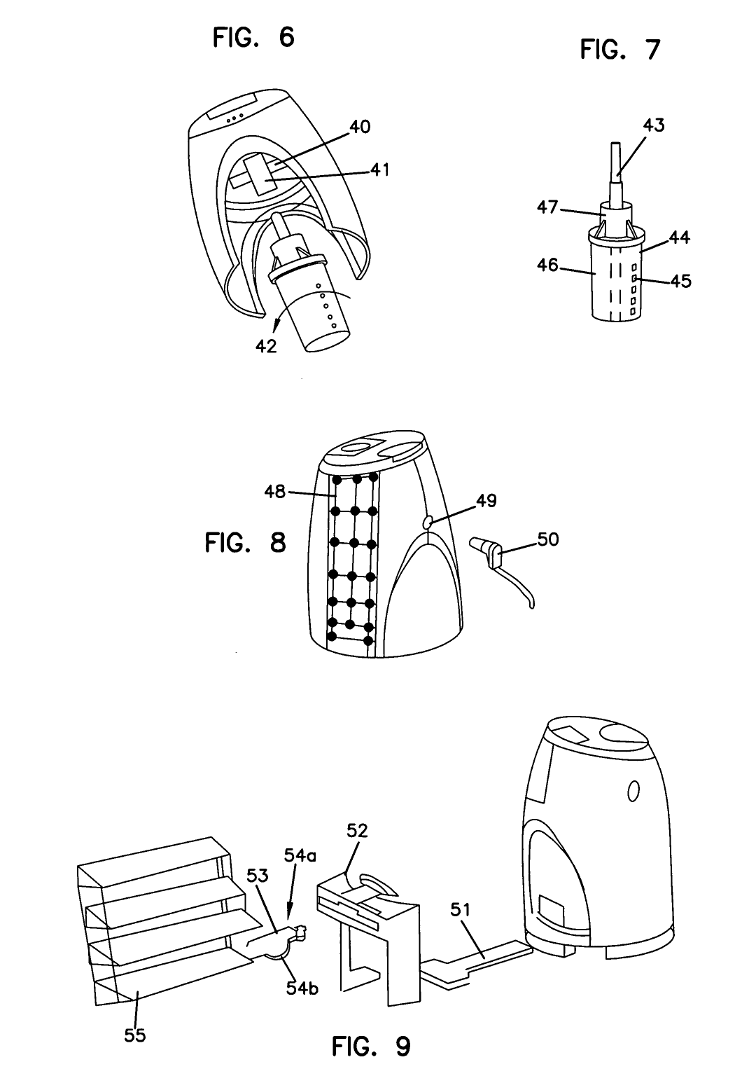

Mesh plate 33 is a relatively thin plate having a plurality of holes 37. Mesh plate 33 may be about 0.02 mm thick. The diameter of the holes 38 at front surface is preferably approximately 2-15 .mu.m in diameter. Such holes may be formed in the plate by an electroforming process, which process produces holes of increasing diameter toward rear surface 40 shown in FIG. 6 of the drawing. However, the straight holes, (not shown) will work equally well, the primary criterion being that the exit diameter in front surface 33 be such as to form droplets of the desired size.

The thinness of mesh plate 33 limits its ability to resist excessive forces generated by liquid pressures in volume. Liquid pressure in volume may also cause leaks through holes 37. To insure the proper supply of liquid from wick 46, sensing elements, such as a pair of spaced electrodes, are fitted in housing 6 to sense the presence or absence of the liquid in volume 80. Electrodes may be mounted in surface of housing 6 adjacent the outlet of wick 46. Front surface 33 of mesh plate 33 is exposed to the pressure of the breathing gases in breathing circuit 2. These pressures will vary during inhalation and exhalation conditions in breathing circuit 2.

In operation, valve 40 is opened responsive to a signal from piezoelectric element control unit 32 and liquid flows through filter 43 and wick 46 due to the pressurizing gas in reservoir 39a and 29. The liquid flows out the end of wick 46 into contact with the upper surface of mesh plate 33. The cohesive forces in the liquid form the liquid into a column of liquid extending between the end of wick 46 and mesh plate 33. Piezoelectric element 32 is energized from a high frequency source in control unit 33 through cable and terminals in housing 6 to vibrate mesh plate 33. The positioning and energization of piezoelectric element 32 may be such as to cause mesh plate 33 to move toward and away from the end of wick 46 and the liquid being discharged therefrom. The vibrations cause the liquid in volume to pass through holes 37 in mesh plate 33.

At the front surface 33 of the vibrating mesh plate 33, the atomized liquid will grow into drops at each hole 37 due to the liquid surface tension. The drops will increase in size until the expelling forces arising from the movement of mesh plate 33 and the mass of each drop, exceeds the holding force determined by the size of the holes 37 in mesh plate 33, and the surface tension of the liquid. The fine spray drops expelled from plate 33 pass through the opening in mist cover 9 into the environment external to the apparatus.

To control the transport of liquid from reservoir 10 and 29 into the of atomizing apparatus, electrodes positioned in surface of housing 6, detect the presence of liquid between the end of wick 46 and the rear surface 40 of mesh plate 33 by alteration of the impedance between the electrodes. That is, with the continued supply of liquid, the column will start to bulge and the impedance measured between the electrodes will be significantly altered. A signal from electrodes is inputted to an impedance sensor and control unit of piezoelectric element 32 via conductors and cable and used to control valve 30 and 41 in liquid supply filter 43 to close the valve. When the impedance changes, due to the liquid receding away from electrodes, the control valve 30 and 41 opens to again allow flow of liquid from the end of wick 46. The supply of liquid in the solar heated and powered ultrasonic air freshener diffuser apparatus of the present invention may thus be characterized as being of the “on demand” type. The delivery of atomized liquid can be controlled by continuously vibrating mesh plate 33 and regulating the liquid transport control or by regulating the activation of mesh plate vibration and intermittently supplying liquid when the amount of liquid in volume is reduced.

Alternatively, the presence of liquid in volume could be measured by an optical sensor, (not shown), that senses changes in light transmission or reflection caused by the liquid in volume. When there is no liquid on mesh plate 33, light from light source is reflected off the mesh plate to detector. The presence of liquid alters the light path.

The proper supply of liquid through the on-demand delivery from wick 46, as controlled by electrodes, provides the following advantages. If too much liquid were to be delivered to volume, liquid would pressurize mesh plate 33 and might leak through mesh plate 33. And, if too much liquid were to be delivered to volume, pressure balancing channel could be occluded. This could also result in undesired pressures being applied to mesh plate 33.

If too little liquid is delivered to volume, the liquid from wick 46 may not cover all the holes 37 in mesh plate 33. However, the pressure balancing provided by channel avoids breathing gas flow through the holes in mesh plate 33 in opposition to the liquid being atomized which might otherwise degrade the operation of solar heated and powered ultrasonic air freshener diffuser apparatus.

Position insensitivity for solar heated and powered ultrasonic air freshener diffuser apparatus is obtained by locating the end of wick 46 sufficiently close to rear surface 40 of mesh plate 33 that the surface tension in the column of liquid will maintain the column between the end of wick 46 and rear surface 40 of mesh plate 33. Since liquid is incompressible, should solar heated and powered ultrasonic air freshener diffuser apparatus be slightly tipped to the side, as in the case of the motion of a moving automobile, from the position shown in FIG. 1, the liquid in wick 46 will support the liquid column in volume so that operation of the solar heated and powered ultrasonic air freshener diffuser apparatus is maintained.

In an alternative embodiment (not shown) of the solar heated and powered ultrasonic air freshener diffuser apparatus originally shown in FIG. 1, mesh plate 33 could be formed using a conductive material such as nickel, which enables it to function as an electrode for liquid level measurement in volume. Mesh plate 33 could rests on annular disc having an opening. Said annular disc may be made of a conductive material that is inert with respect to the liquid to be atomized and to the breathing gases. Said disc could form the base of housing 6a. Housing 6a may be completed with a non-conductive sidewall and a non-conductive top plate. Said top plate may be removable to allow cleaning of the interior components of solar heated and powered ultrasonic air freshener diffuser apparatus. Mesh plate 33 may be electrically connected to disc and to conductor.

Sidewall has an aperture that accommodates wick 46. Unlike the embodiment of FIG. 4, the cavity or volume could be filled with liquid from the side of apparatus rather than from the top.

Conductive actuator coating 39a and plate 33 are mounted in interior housing 6 sidewall as by the upright flange around its perimeter, which is directed away from the mesh plate 33. Plate 33 has several purposes. First, plate 33 mounts ultrasonic vibration generator, preferably a piezoelectric element 32. Ultrasonic vibration generator is affixed to plate 33. Second, plate 33 functions as a liquid level detector in space by serving as an electrode for measurement in conjunction with conductive mesh plate 33a.

In operation, liquid flows into volume from wick 46. A control valve 30 and 41, such as shown in FIG. 5 is used to control the liquid transported into volume. When the liquid makes contact with mesh plate 33a and with plate 33 serving as sensing electrodes, the impedance measurement between plate 33 and mesh plate 33a changes. The control valve 30 and 41 is closed, to be thereafter opened when the liquid level recedes to the point where contact with plate 33 is lost.

Piezoelectric element 32 vibrates the liquid by inducing pressure waves from plate 33. The piezoelectric element 32 is energized by electrical power source in control unit of piezoelectric element 32 through cable. The vibrating liquid is atomized as it passes through holes 37 and discharged into the breathing gases.

Thus, while in solar heated and powered ultrasonic air freshener diffuser apparatus of FIG. 1, mesh plate 33 is vibrated by the piezoelectric element 32, in solar heated and powered ultrasonic air freshener diffuser apparatus shown in FIG. 5, the liquid in volume is vibrated by the piezoelectric element 32.

The embodiment of the invention shown in FIG. 4 differs from that shown in FIG. 1 in that control valve 30 in control unit of piezoelectric element 32 supplies liquid directly to wick 46 from a liquid source (not shown). Cable obtains electrical signals from the liquid level sensors in solar heated and powered ultrasonic air freshener diffuser apparatus for use by control unit of piezoelectric element 32 in controlling hydrostatic control valve 30. The pump is turned off when the impedance detected by the liquid level sensors indicates that the appropriate amount of liquid has been provided to solar heated and powered ultrasonic air freshener diffuser apparatus. Use of the control valve 30 shown in FIG. 5 has advantages over the pressurizing gas in that some fragranced liquid essential oils cannot be exposed to the pressurizing gas without deleterious effects.

In the embodiment of FIG. 5, the force used to transport the liquid to the solar heated and powered ultrasonic air freshener diffuser apparatus is obtained hydrostatically. The liquid source, such as liquid reservoir 39a and 29a, can be arranged at an elevated position with respect to solar heated and powered ultrasonic air freshener diffuser apparatus, to generate a pressure head to supply liquid to the apparatus. Liquid supply 39a and 29a may comprise a flexible pouch or bag to create a hydrostatic pressure for causing liquid to flow through wick 46 when control valve 30 and 41 is opened. The arrangement shown in FIG. 5 is especially suitable for atomizing the large amounts of liquid often required in continuous long-term diffusion. The embodiment of FIG. 5 has the advantage in that it will use less energy, and be less noisy, than embodiments using gas or liquid pumps.

In the embodiment of the invention shown in FIGS. 4 and 5, cavity 26 is pressurized by gravitationally supplying a liquid to chamber 26. In the embodiment of the invention shown in FIGS. 4 and 7, the cavity chamber 26 is pressurized by filter pump 43. The pump may be located, for example, in control unit of piezoelectric element 32 (shown in FIGS. 4 and 5) and connected to reservoir 39a and 29 by wick 46. Pump 43 may be either a liquid or gas pump. In operation, filter pump 43 is regulated by control unit of piezoelectric element 32.

Disc-like plate, comprised of a conductive material such as brass, is sealed to lip by O-ring. Plate 33 contains a central opening. The surface of plate 33 which is the lower surface when the solar heated and powered ultrasonic air freshener diffuser apparatus is oriented as shown in FIG. 1 mounts mesh plate 33b containing holes 37. Mesh plate 33a may be mounted to plate 33 by gluing, brazing, welding, or other suitable technique.

Piezoelectric element 32 is mounted on the upper surface of plate 33. Specifically, piezoelectric element 32 is spaced from plate 33 by a small gap and secured to plate 33 about its periphery by a conductive glue, brazing, welding, or other suitable technique. Piezoelectric element 32 has a central opening corresponding to that of plate 33.

Optional plug member 50 formed of a non-conductive material, such as plastic, is placed in cavity 26b of housing 6b. Plug member 50 has depending lip containing O-ring. Plug member 50 is placed on top of plate 33 so that the plate is between O-rings.

A central liquid wick 46 extends through plug member 50 to approximately the upper surface of plate 33. A small domed cavity may be formed in the lower surface of plug member 50 to surround wick 46. Wick 46 may be formed of a conductive material to allow its use in impedance measurement of the presence of liquid in solar heated and powered ultrasonic air freshener diffuser apparatus 31.

An electric power terminal extends through battery or optional plug member 50. The lower end of terminal, which terminal may be in the form of a spring loaded pin, contacts piezoelectric element 32. The upper end of terminal is connected to cable. A second electrical power terminal may also extend through plug member 50. The lower end of terminal contacts conductive plate 33. The upper end of terminal is connected to cable. Terminal may be electrically grounded for purposes of applying a voltage to piezoelectric element 32 in conjunction with terminal, as well as for impedance measurement in conjunction with conductive wick 46.

G) Diffusion of Atomized Liquids or Suspensions (Claims 2 and 3)

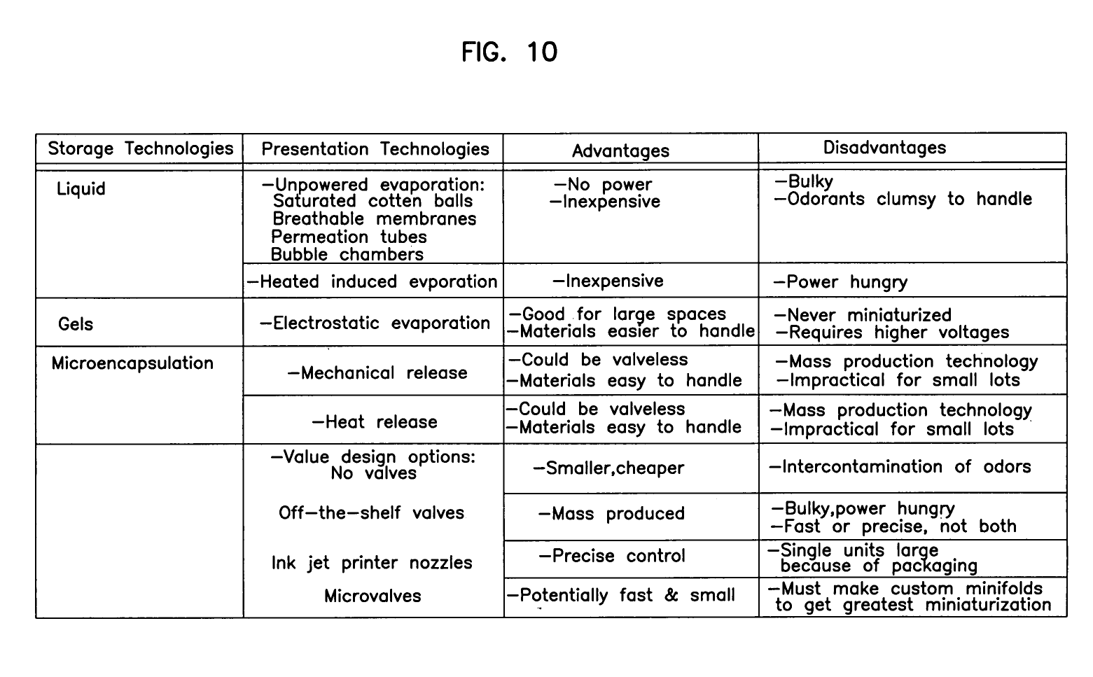

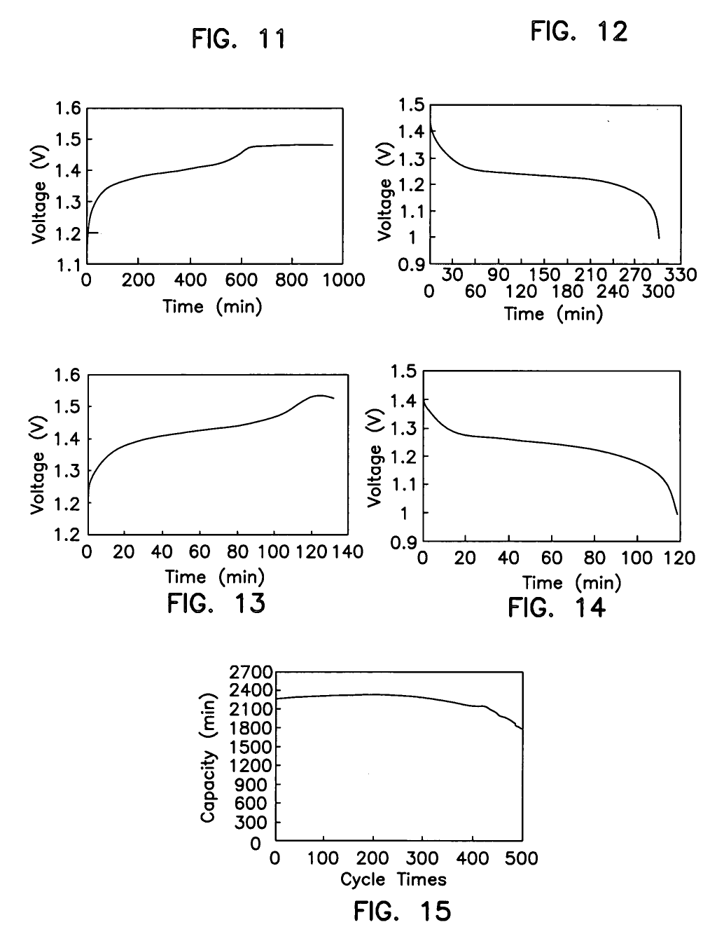

As shown in FIG. 10 ‘Olfactory Delivery Technologies’, there are a variety of vapor diffusion techniques, with a variety of corresponding advantages and disadvantages. FIG. 10 illustrates that while liquid fragrances are commonly evaporated through both powered heat induction and by un-powered means in devices such as saturated cotton balls, breathable membranes, permeation tubes, and bubble chambers, gel fragrances are commonly evaporated or sublimated by means of electrostatic charges from electrical devices. A third type of fragrance storage technology, (the first two being liquids and gels) micro-encapsulation of liquids, solids or gels achieves evaporation through mechanical means, heat release, or through pressure release from valves. In choosing between these storage technologies trade-offs in terms of performance, cost and ease of production vary significantly. Beginning with liquids, un-powered evaporation is inexpensive to make and operate, but they diffuse fragrances in a non-uniform manner, often releasing a burst of scent at the onset and quickly in 3 to 5 days losing their effectiveness to negate malodors. If made in larger sizes to provide additional strength and extended life, they also can be bulky and clumsy to handle. In the case of gels, electrostatic evaporation is good for large spaces, but they require continuous feed of higher voltages. As for liquids as used in the present invention, they can be mass-produced to create significant cost economies of scale to lower unit cost to consumer and quality of diffusion is among the most uniform due to the store and release of scent over time in multiple cells. The conclusion is that with heat-induced atomization of liquids, scent is more evenly diffused, but the method can be power hungry, although with solar power at least the energy source is renewable and naturally abundant.

Atomized Liquid Diffusion (Claims 2 and 3)

In an exemplary embodiment as stated in claim 2, the apparatus for absorbing and transferring solar energy according to claim 1 wherein said means for affecting atomized liquid movement is achieved by natural air flow through an ornamental cover with vent openings for communication of said atomized liquids or suspensions to the surrounding environment, with the previous liquid atomization and diffusion processes being accelerated by the solar heated condition imposed thereon. In operation, alternating voltage is supplied from power source through cable and terminals to piezoelectric element 32 which vibrates the element. The vibrations cause the element to contract from the normal condition, to a radially decreased condition and then return to the normal condition. Due to the joinder of piezoelectric element 32 to plate 33 about the periphery of the element, the radial size reduction of piezoelectric element 32 causes plate 33 to bow, and then return to the flat condition, when piezoelectric element 32 returns to the normal state. The action of plate 33 discharges atomized liquid from holes 37 in mesh plate 37.

In an alternative embodiment as stated in claim 3, the apparatus for absorbing and transferring solar energy according to claim 1 wherein said means for affecting atomized liquid movement is achieved by connecting the present invention, with its attachable clip 53, to the louvers 55 of a building or an automobile's ventilation system that, when blowing air, provides additional movement beyond that of ambient air movement to aid in diffusion of fragrance into the air inside of a room or an automobile. The clip element 53 comprises a clamping elements 54a and 54b projecting outwards from the housing, the top and bottom clamping elements 54a and 54b being separated from each other according to two planes which are at least substantially perpendicular to each other, to enable securing the air-freshener either on a vertical, or on a horizontal strip-shaped element. The clamping elements are formed by polymer or metal strips provided, at least at the ends thereof, with a polymer covering layer.

H) Administrative Functions

In an exemplary embodiment as stated in claim 2, user administrative functions over the apparatus include automated timer switch to turn the device OFF after such length of time of continuous operation that liquids are predictably depleted from the liquid reservoir, Light Emitting Diode (LED 20) operational status indicator, and means for manual actuation to turn the apparatus ON and OFF 8, 17, 18, 19.

A timer switch assembly is connected via wire to the conducting clips contacting the batteries 11, and each time the unit is turned on for operation, internal digital clock mechanism of said timing switch assembly begins counting in seconds and minutes. When said internal digital clock mechanism has cumulatively reached a predetermined number of minutes to correspond to a predicted amount of time that the apparatus would need to continuously run before all liquids are depleted from the liquid reservoir 10 and 29, a shut-off breaker is automatically triggered to stop the supply of voltage from the battery to the On/off 8, 17, 18, and 19 control switch, thereby terminating operation of the apparatus.

There is an aperture through which heater On/off 8, 17, 18, and 19 control switch is mounted, an integral channel is provided for enabling the emission of light from light-emitting diode (LED 20) operational status indicator into the interior of the system housing. Furthermore, integral channel is provided for enabling the emission of light from light-emitting diode (LED 20) into the interior of the system housing. Channel is oriented such that light emitted from LED 20 is directed toward a contact portion of an actuation member for encouraging the transmission of the emitted light through the contact portion. In this manner, the contact portion has the appearance of being lit.

As best illustrated in FIG. 3, support body upper surface includes an aperture (not shown) through which heater and atomization On/off 8, 17, 18, and 19 control switch 8 is mounted, as well as an indentation along its front edge to prevent interference with latch.

Having thus described the preferred embodiments in some detail it will be clear to those having ordinary skill in the art that obvious modifications could be made to the system without departing from the spirit of the invention. Such obvious modifications are within the inventive concept. It will be apparent that various modifications can be made in the particular solar energy apparatus described in detail above and shown in the drawings within the scope of the invention. For example, the size, shape, and configuration of the components can be changed to meet specific requirements. Also, the solar energy absorbing members can be disposed in various orientations provided the operation and functioning of the apparatus are not deleteriously affected. In addition, the solar energy absorbing material can be arranged differently in the absorbing members. Various changes may be made in shape, size and arrangement of parts. For example, equivalent elements or materials may be substituted for those illustrated and described herein. Parts may be reversed, and certain features of the invention may be utilized independently of the use of other features, all as would be apparent to one skilled in the art after having the benefit of having this description of the invention. It is not intended that the words used to describe the invention nor the drawings be limiting on the invention, rather the only limitations placed are those in the appended claims.

1. An air freshener apparatus to atomize and diffuse liquids or suspensions into a mist by means of conversion of collected solar energy into thermal radiation passed through a wire for optionally heating said liquids and conversion of solar energy into electrical energy stored in batteries and used for subsequent atomization of said optionally heated liquids by means of piezoelectric ultrasonic vibrations. In one embodiment, the resulting mist and fragranced aromas of atomized liquids or suspensions are communicated through housing vent openings to an external environment such as a room or an automobile. In an alternative embodiment, additional diffusion of said atomized liquids and associated fragranced aromas is achieved by means of connecting the present invention, with its attachable clip, to the louvers of a building's or an automobile's ventilation system that, when blowing air, provides additional diffusion of fragrance into the air inside of a building or an automobile.

2. An air freshener apparatus according to claim 1, which deploys passive solar collection, solar energy transfer, energy storage, atomization of a plurality of liquids or suspensions via a piezoelectric atomization process, and consisting of a plurality of solar absorbent thin films and panels such as amorphous silicon (ASi) or micro-crystalline silicon (m-Csi) or cadmium telluride thin films or solar mini-panels for absorbing and transferring solar energy aided by means of placing the apparatus to the inner side of and to work in conjunction with conventional glass panes found in buildings and automobiles (as determined by the temperance, thickness, and emissivity standards of the Uniform Building Code and the United States Department of Transportation, National Highway Traffic Safety Administration, and the Federal Motor Vehicle Safety Standards, respectively) for the apparatus to capture direct sunlight with the short wave sun rays being favorably amplified and long wave sun rays partially filtered by said glass in buildings or automobiles, batteries for storing absorbed and transferred solar energy, a reusable housing into which a container for a volatile liquid, suspension, or a liquid containing one or more volatile components can be inserted, in the opening of which container a snugly fitting wick extending into the container and into housing is fitted, a rubberized gasket sealant at and around the neck of the container, an optional positive coefficient temperature (PCT) thermistor for receiving communicated solar energy, a optional resistor for modulating heat from said solar energy, a timer switch assembly, an aperture through which heater On/Off control switch is mounted, an integral channel is provided for enabling the emission of light from light-emitting diode (LED) into the interior of the system housing, sheathed electrical wires for receiving heat communicated from said optional PCT thermistor and resistor to optionally heat said liquids or suspensions for more rapid absorption into said wick, a housing with an opening covered by a thin mesh plate that is supplied with the liquid to be atomized on an “on-demand” basis wherein the mesh plate or liquid is vibrated at ultrasonic frequencies to atomize the liquid as it passes through the plate into the diffusion chamber, and an ornamental cover with vent openings for communication of said atomized liquids or suspensions.

3. An air freshener apparatus according to claim 1, wherein the clip element comprises clamping elements projecting outwards from the housing, the clamping elements being separated from each other according to two planes which are at least substantially perpendicular to each other, to enable securing the air-freshener either on a vertical, or on a horizontal strip-shaped element. The clamping elements are formed by polymer or metal strips provided, at least at the ends thereof, with a polymer covering layer.
